(19) United States
(12) Patent Application Publication
(10) Pub. No.: US 2013/0006742 A1
(43) Pub. Date: Jan. 3, 2013

(54) METHOD AND SYSTEM FOR GENERATING A DYNAMIC PURCHASE INCENTIVE

(75) Inventor: Postrel Richard, Miami Beach, FL (US)

(73) Assignee: Signature Systems LLC, Miami Beach, FL (US)

(21) Appl. No.: 13/173,479

(22) Filed: Jun. 30, 2011

(51) Int. Cl. G06Q 30/00

(52) U.S. Cl. 705/14.25; 705/14.1; 705/14.38; 705/14.35; 705/14.27; 705/14.34

(57) ABSTRACT

A computer-implemented method of providing a dynamic purchase incentive to a purchase of a product. A product identification is input into a purchasing device which transmits it to a discount server computer along with customer identification data. The discount server computer uses the product identification to retrieve from a product discount database associated product discount data, and uses the customer identification data to retrieve from a customer profile database associated customer profile data. The discount server computer uses the retrieved customer profile data and the product identification to generate a dynamic purchase incentive to be applied to the purchase of the product by the customer, the incentive varying as a function of the retrieved customer profile data and the product identification. The discount server computer transmits the purchase incentive to the purchasing device, and the purchase incentive is applied to the purchase of the product by the customer.

### TECHNICAL FIELD

This invention relates to purchase incentive systems, and in particular to a method and system for generating a dynamic purchase incentive that varies as a function of several parameters including a customer profile and a purchase incentive database.

### BACKGROUND OF THE INVENTION

Purchase incentive systems such as discount coupons are utilized in an effort to provide an incentive for a customer to purchase a product. In the field of coupons, they are typically printed on paper and made available to customers via various distribution modes such as mailing, newspaper inserts, etc. These coupons will have a fixed discount amount printed on the coupon, along with an expiration date. Coupons may also be distributed electronically through email messages, or they may be posted on a web site and printed out by the customer as desired.

It is desired however to provide an incentive system and methodology that can adapt an incentive to a particular customer, as well as vary the incentive in accordance with the desires of the product provider that may vary in real time based on various parameters. Since prior art incentive systems provide fixed incentives, they cannot meet these desires.

### SUMMARY OF THE INVENTION

Provided therefore is a computer-implemented method of providing a dynamic incentive to a purchase of a product (which may be a good, a service, or a combination of a good and service). A product identification that identifies a product desired to be purchased by a customer is input into a purchasing device. The purchasing device transmits to an incentive server computer the product identification and customer identification data that identifies the customer. The incentive server computer uses the product identification to retrieve from a purchase incentive database associated product incentive data (which may include an initial incentive amount to be used in the dynamic purchase incentive). The incentive server computer also uses the customer identification data to retrieve from a customer profile database associated customer profile data (which may include prior purchase history data of the customer and/or demographic data associated with the customer). The incentive server computer uses the retrieved customer profile data and the product incentive data to generate a dynamic purchase incentive to be applied to the purchase of the product by the customer, the dynamic purchase incentive varying as a function of the retrieved product incentive data and the retrieved customer profile data. For example, the incentive server computer may vary the initial incentive amount retrieved from the purchase incentive database as a function of the customer profile data retrieved from the customer profile database. The incentive server computer transmits the dynamic purchase incentive to the purchasing device, and the dynamic purchase incentive is applied to the purchase of the product by the customer.

The product identification may be input into the purchasing device by scanning a bar code such as a UPC associated with the product, the bar code being encoded with the product identification. In the alternative, the product identification may be input into the purchasing device by reading a radio frequency identification tag associated with the product, the radio frequency identification tag being encoded with the product identification. Or, the product identification may be input into the purchasing device by using near field communications (NFC) technologies. Similarly, the product identification may be input into the purchasing device by entering a text description of the product into a keyboard of the purchasing device.

The purchasing device may a point-of-sale terminal, in which case the dynamic purchase incentive is applied to the purchase of the product in real-time when the dynamic purchase incentive is received from the incentive server computer. In the alternative, the purchasing device may be a portable hand-held device, in which case the dynamic purchase incentive may be stored in a memory in the portable hand-held device to be applied to the purchase of the product at a subsequent time. Optionally, a plurality of purchase incentives may be generated by the incentive server computer and transmitted to the purchasing device, each of the purchase incentives being associated with a product to be purchased by the customer. The plurality of purchase incentives are then stored at the purchasing device for subsequent use by the customer in purchasing the associated products.

A notification may be transmitted to the incentive server computer indicating that the dynamic purchase incentive has been applied to the purchase of the product by the customer (redeemed), and the notification may then be stored in a product incentive redemption history file. The incentive server computer may then analyze the product incentive redemption history file in addition to the retrieved product incentive data and the retrieved customer profile data in order to generate the dynamic purchase incentive to be applied to the purchase of the product by the customer.

The incentive server computer may also analyze a product provider profile file in addition to the retrieved product incentive data and the retrieved customer profile data in order to generate the dynamic purchase incentive to be applied to the purchase of the product by the customer. The product provider profile file may be provided by a manufacturer of the product, a merchant of the product, and/or a purchasing club. The product provider profile file may be integrated into the purchase incentive database, or it may reside in a separate database if desired.

The incentive server computer may also use, in addition to the retrieved product incentive data and the retrieved customer profile data in order to generate a dynamic purchase incentive to be applied to the purchase of the product by the customer, current weather data, predictive weather data, calendar data, time data, and/or product inventory data. The purchasing device may transmit to the incentive server computer location data (such as GPS data) that identifies the location of the purchasing device, and then the incentive server computer may use the location data in addition to the retrieved product incentive data and the retrieved customer profile data in order to generate a dynamic purchase incentive to be applied to the purchase of the product by the customer.

The dynamic purchase incentive may include a discount coupon that gives the customer a discount on the purchase of the product, a discount coupon that gives the customer a discount on the purchase of a second product complementary to the product, reward points that are awarded to an account associated with the customer, and/or a rebate.

Optionally, the transmitted purchase incentive may be logged in a distributed purchase incentives file at the incentive server computer. Then, subsequent purchase incentives may be limited based on the transmitted purchase incentives logged in the distributed purchase incentives file.

In one embodiment, the customer is a member of a group of related customers, and each related customer has an associated customer profile stored in the customer profile database. The customer profiles associated with each of the related customers in the group are retrieved from the customer profile database and used in order to generate a dynamic purchase incentive to be applied to the purchase of the product by the customer. For example, the customer profile of each of the group of related customers may additionally include a group identification number that is the same for each of the related customers, and then the customer profiles associated with each of the related customers in the group are retrieved from the customer profile database by referencing the group identification number.

The above-described methods may be carried out by a dynamic incentive purchasing system that includes a purchasing device and an incentive server computer selectively interconnected with the purchasing device over a network.

The purchasing device has an input module for inputting a product identification that identifies a product desired to be purchased by a customer, and a first data transmission communications module for transmitting over a network to the incentive server computer the product identification and customer identification data that identifies the customer, and for receiving from the incentive server computer a dynamic purchase incentive to be applied to the purchase of the product by the customer.

The incentive server computer has a second data transmission communications module for receiving from the purchasing device the product identification and customer identification data that identifies the customer, and for transmitting to the purchasing device the dynamic purchase incentive to be applied to the purchase of the product by the customer. The incentive server computer also has a purchase incentive database that stores product incentive data associated with product identification data and a customer profile database that stores customer profile data (which may include prior purchase history data of the customer and/or demographic data associated with the customer) associated with customer identification data. Processing circuitry is programmed to use the product identification data to retrieve associated product incentive data from the purchase incentive database, use the customer identification data to retrieve associated customer profile data from the customer profile database, and analyze the retrieved product incentive data and the retrieved customer profile data to generate the dynamic purchase incentive to be applied to the purchase of the product by the customer, the dynamic purchase incentive varying as a function of the retrieved product incentive data and the retrieved customer profile data.

In this system, the input module of the purchasing device may include a bar code scanning module for scanning a bar code associated with the product (such as a UPC), the bar code being encoded with the product identification. For example, the bar code scanning module may include an image capture device such as a camera for capturing an image of the bar code from the product. In the alternative, the input module may include a radio frequency identification tag reading module for reading a radio frequency identification tag associated with the product, the radio frequency identification tag being encoded with the product identification. Or, the input module may include a near field communications module for reading an NFC encoded device. The input module may also be a keyboard for entering a text description of the product into the purchasing device.

In an alternative embodiment, purchase incentives are pushed to the customer rather than being pulled (requested) by the customer. In this case, the purchasing device transmits to the incentive server computer location data (such as GPS data) that identifies the location of the purchasing device and customer identification data that identifies a customer associated with the purchasing device. The incentive server computer retrieves product incentive data from a purchase incentive database and uses the customer identification data to retrieve associated customer profile data from a customer profile database. The incentive server computer uses the retrieved product incentive data and the retrieved customer profile data to generate a dynamic purchase incentive to be applied to the purchase of the product by the customer, the dynamic purchase incentive varying as a function of the retrieved product incentive data and the retrieved customer profile data. The incentive server computer transmits the dynamic purchase incentive to the purchasing device so that the customer may apply the dynamic purchase incentive to the purchase of the product.

To accomplish this, the incentive server computer compares the location data received from the purchasing device with a predefined location perimeter (such as a retail store) stored at the incentive server computer, and then the incentive server computer generates the dynamic purchase incentive only when the incentive server computer determines that the purchasing device is near the predefined location perimeter based on the location data comparison. The product incentive data retrieved from the purchase incentive database at the incentive server computer is associated with the predefined location perimeter (i.e. the retail store).

In another alternative embodiment, a non-registered customer (i.e. a customer having no customer profile stored at the incentive server computer) may utilize the invention as follows. A product identification that identifies a product desired to be purchased by a customer is input into a purchasing device, such as a POS terminal. The purchasing device transmits the product identification to the incentive server computer. The incentive server computer uses the product identification to retrieve associated product incentive data from a purchase incentive database, and the incentive server computer uses the retrieved product incentive data to generate a dynamic purchase incentive to be applied to the purchase of the product by the customer, the dynamic purchase incentive varying as a function of the retrieved product incentive data. The incentive server computer then transmits the dynamic purchase incentive to the purchasing device.

### BRIEF DESCRIPTION OF THE DRAWING

FIG. 1 is a block diagram of the preferred embodiment of the present invention.

FIG. 2 is a flowchart of the overall operation of the preferred embodiment of the present invention.

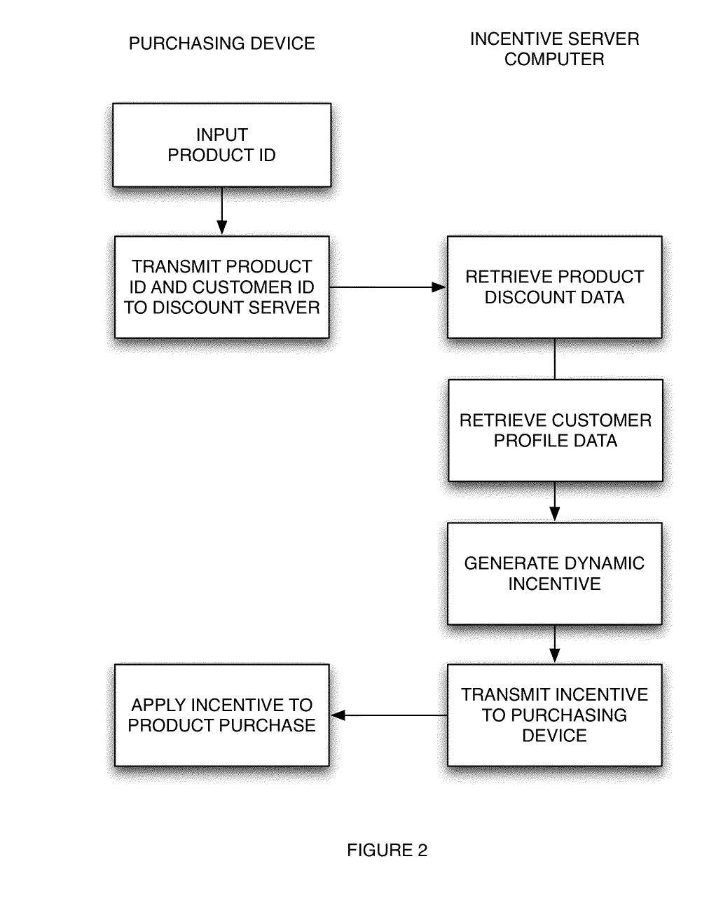

FIG. 3 is an illustration of the customer profile database of FIG. 2.

FIG. 4 is an illustration of the product database of FIG. 2.

### DESCRIPTION OF THE PREFERRED EMBODIMENTS

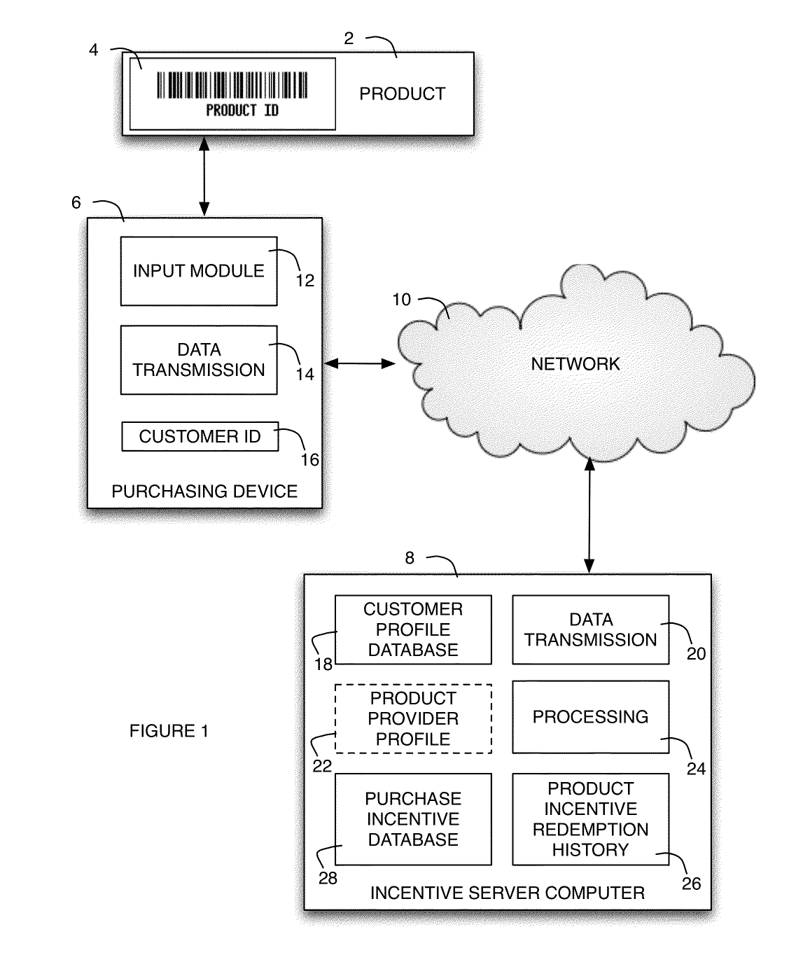

Referring generally to the Figures, the preferred embodiment of the present invention will now be described. FIG. 1 illustrates a block diagram of a real-time variable incentive purchasing system that includes a purchasing device 6 and an incentive server computer 8 selectively interconnected with the purchasing device over a network 10. The network 10 may be a wide area computer network 10 (WAN) such as the Internet, or it may be a local area network (LAN) operating within an enterprise, or it may be a combination of LANs and WANs. The network 10 may also incorporate a wireless network such as a cellular telephone network that can transmit data as well known the art. The network 10 may be a combination of wireless and wired networks as well. The purchasing device 6 may take on one of several form factors within the scope of this invention. In one embodiment, the purchasing device 6 is a portable hand held device such as a smartphone that incorporates a display, input devices that may include a touchscreen and/or dedicated buttons, an imaging device (camera), a sound output such as a speaker or headset jack, computing circuitry including processing circuitry and memory, GPS radio, wireless communications devices for communicating with the network 10, and other circuits and interfaces as well known in the art. For example, the purchasing device 6 may be an IPHONE device manufactured by APPLE, INC., or it may be an ANDROID operating system based device, etc. The purchasing device 6 may also be a tablet device such as an IPAD. These devices are programmable with applications (apps) that provide desired functionality for the user. In this embodiment, the IPHONE is used as the portable hand held purchasing device 6 and is programmed with a purchasing app to provide the functionalities that will now be described.

The purchasing device 6 has an input module 12 for inputting a product identification that identifies a product 2 that is desired to be purchased by a customer. The product identification (ID) 4 is shown in FIG. 1 as a bar code, which is typically a UPC (universal product code). The UPC is well known in the art and has been in use for decades. Typically, the UPC has two parts; a manufacturer ID and an item ID. The manufacturer ID is the first several digits of the code, and is unique to each product manufacturer that uses the UPC system. Each manufacturer then assigns an item ID to each of its products. The item ID is the second part of the UPC code; the manufacturer ID and item ID therefor constitute the UPC code. As such, each UPC is unique to a product and can uniquely identify the manufacturer as well as the product, as well known in the art. The preferred embodiment uses the UPC since each UPC can uniquely identify the manufacturer and the product; however other bar code symbologies may be used within the spirit and scope of this invention (for example, the EAN system is used in Europe to identify products and the ISBN (International Standard Book Number) is used to uniquely identify books). Other codes such as two-dimensional codes (e.g. QR codes) may also be used with this invention. Therefore, in this bar code scanning embodiment of the invention, the product ID 4 is the UPC found in almost all products in commerce.

The input module in this embodiment is a bar code scanning device, and in particular for the smartphones the built-in camera is used as the bar code scanning device. That is, the camera of the smartphone is used to capture an image of the bar code, and the application software can decode the bar code image to provide the product ID that was encoded into the UPC. Programs for capturing an image of a bar code and decoding the bar code are well known in the art. Other types of bar code scanning mechanisms may be used as well, such as laser scanning modules, but it would be preferred to use the onboard camera as described since that device is readily available and integrated into the smartphone.

Also shown in FIG. 1 is a (first) data transmission communications module 14, which provides wireless data input and output for the smartphone purchasing device 6 as well known in the art. In this invention, the first data transmission communications module 14 is used for transmitting over the network 10 to the incentive server computer 8 the product ID 4 and customer identification data 16 that identifies the customer. The first data transmission communications module 14 is also used for receiving from the incentive server computer 8 a dynamic purchase incentive to be applied to the purchase of the product 2 by the customer as will be described further herein.

The customer ID 16 may be any type of data that serves to uniquely identify the customer who will be receiving the purchase incentive for the product 2. The customer ID may be a customer name or customer number stored in memory in the purchasing device 6. For example, the application that executes on the purchasing device 6 that executes the functionalities described herein may require the customer to enter his or her name as part of a registration process as well known in the art. The name, or a correlated number, would then be provided back to the incentive server computer 8 in order for the incentive server computer to customize the purchase incentives as will be described further below. The customer ID 16 could also be a device identification number that serves to uniquely identify the particular purchasing device 6 that is being used with the system to request the purchase incentive. In an alternative embodiment, the customer would be requested to enter his name or other ID each time he uses the application software to scan the product ID and request a purchase incentive. This would be the preferred manner of using the invention when the purchasing device may be used at different times by different customers, such as when the purchasing device is a point of sale terminal (POS). In this case, the customer brings a desired product to a cashier at the POS terminal, and the cashier scans the UPC or other bar code and asks the customer to enter some identifier. For example, a credit card, debit card, loyalty card or the like may be presented by the customer and the card/account number may be used as the customer ID. Thus, any way of identifying the customer to the incentive server computer is envisioned within the scope of the invention. Thus, in operation, the customer will operate the smartphone purchasing device 6 to scan the UPC on the product 2 that he or she is interested in purchasing, and the purchasing device will decode the UPC to obtain the product ID, and then transmit the product ID along with the customer ID 16 via the network 10 to the incentive server computer 8.

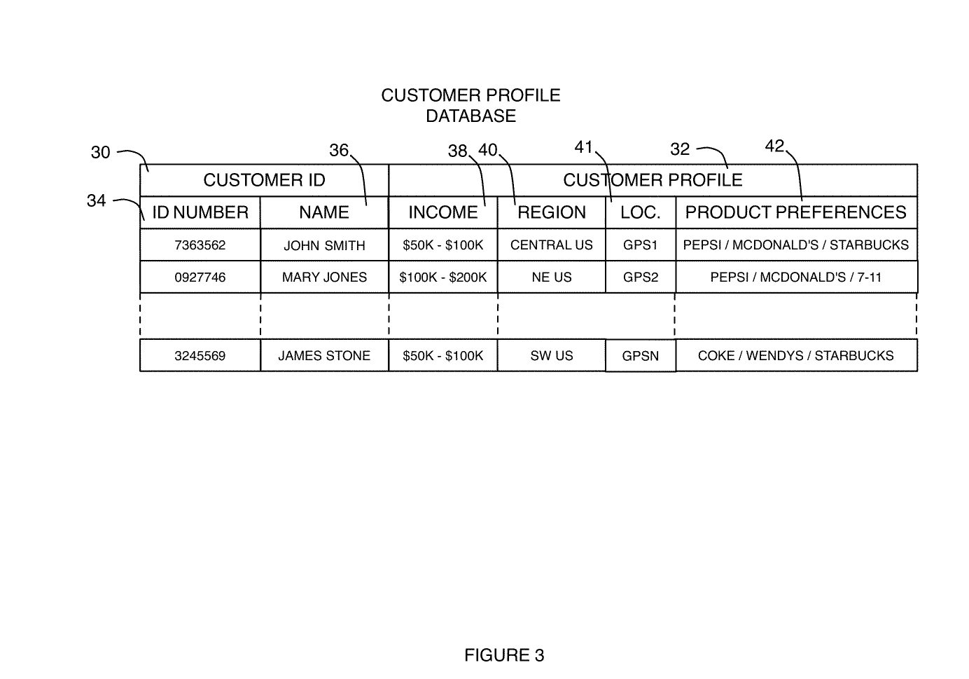

The incentive server computer 8 is also shown in block diagram format in FIG. 1. The incentive server computer 8 has a (second) data transmission communications module 20 for receiving data from the purchasing device 6, including the product identification and customer identification data that identifies the customer as explained previously, and for transmitting to the purchasing device 6 the dynamic purchase incentive to be applied to the purchase of the product by the customer. The incentive server computer 8 also has a customer profile database 18 that stores customer profile data associated with the customer identification data. That is, for each customer that has registered with the system, there will be a customer profile stored in the customer profile database 18 at the incentive server computer. This is also shown in FIG. 3. The customer profile database 18 as shown in FIG. 3 comprises two main sections; a customer ID section 30 and a customer profile section 32. The customer ID section may have an ID number field 34 and/or a name field 36. Either of these fields may serve to uniquely identify the customer that is using the system. The customer profile section 32 may have several fields, such as an income field 38, a region field 40, and a product preferences field 42. Thus, for example, John Smith has registered with the present system and is assigned an ID number by the system, which is 7363562. When John Smith registered he indicated his income as between $50K and $100K per year, and he indicated his region as being in the central part of the United States. More geographic data may be used, such as zip code, if desired. John Smith also optionally entered several product preference questions during his registration process, and in this case has indicated that he prefers PEPSI soda products, MCDONALD'S fast food, and STARBUCKS coffee products. In the alternative, or as a supplement, the present system may collect this preference information from external sources, or it may analyze his shopping habits to generate a prior purchase history as he uses the system, in order to generate the data found in the product preferences field 42. Prior purchase history would indicate products that have been purchased by that customer using the present invention or otherwise, and could also indicate products that have been scanned for purchase incentives but not yet purchased by that customer. More information may be provided in this field as desired, the data shown in FIG. 3 is intended as an example. Essentially any information that may be used by the system to adjust or vary the purchase incentive value provided to a given customer may be stored in this customer profile database 18. Other examples of data in the customer profile include demographic and psychographic data, credit bureau data, behavioral and payment data, and other public records.

In addition to including the demographic data described above for each unique customer, the customer profile data 32 could also include data that is generic to all customers, such as how many customers have purchased the product that was scanned, etc. The processing circuitry 24 is programmed to use the customer identification data received from the purchasing device 6 (i.e. the ID number 34 and/or name 36) to retrieve the associated customer profile data 32 from the customer profile database 18.

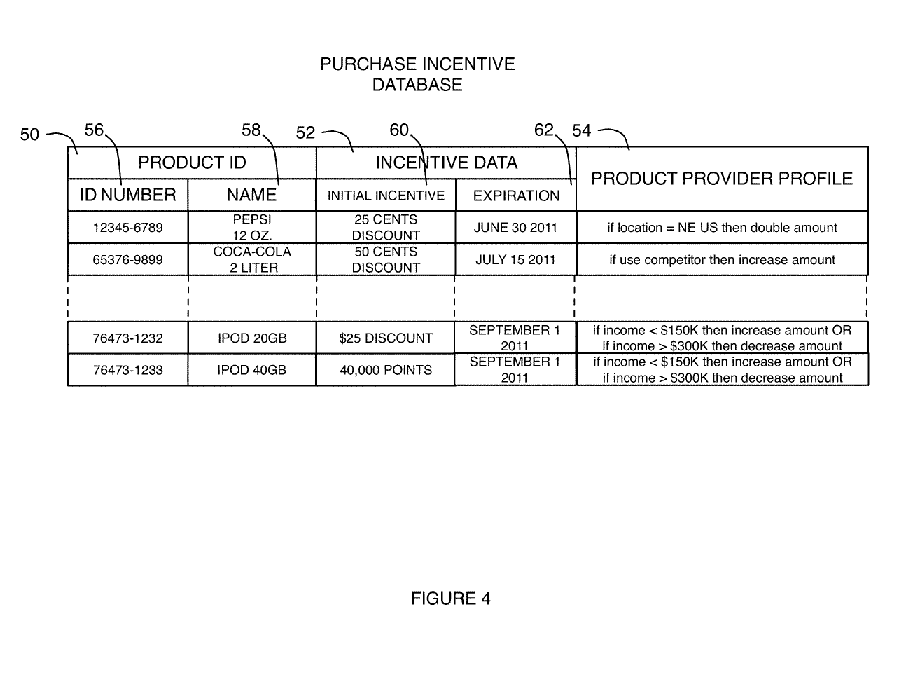

Also shown in FIG. 1 (and in detail in FIG. 4) is a purchase incentive database 28. The purchase incentive database 28 is a repository of product incentive data associated with each product ID available in the system. The product incentive data comprises for example an initial incentive 60 to be used as a starting point in determining the dynamic purchase incentive for the particular customer that has scanned the associated product 2. This initial incentive 60 may be modified as function of the retrieved customer profile data 32 in order to generate the dynamic purchase incentive for use by that customer in purchasing that product.

Thus, as shown in FIG. 4, the purchase incentive database 28 has at least two main sections; a product ID section 50 and a product incentive data section 52. The product ID section 50 may have an ID number field 56 and/or a name field 58. Either of these fields may serve to uniquely identify the product that is registered in the system. The product incentive data section 52 may have several fields, such as an initial incentive field 60 and an expiration date field 62. For example, as shown in FIG. 4, a 12 oz. bottle of PEPSI soda is associated with ID number 12345-6789 (e.g. its unique UPC value). The initial incentive that is used as a starting point for generating the purchase incentive is a 25 cent discount coupon, and the discount for this product will expire on Jun. 30, 2011.

The purchase incentive may be a purchase discount coupon that provides a discount at the time of sale in the amount specified by the coupon. Or, the purchase incentive may be a rebate that is fulfilled after the product is purchased by they customer. Or, the purchase incentive may be a reward such as a certain number of reward points that are earned by the customer as a result of purchasing the product. For example, a customer may scan a product and the incentive server computer returns a purchase incentive indicating that the customer will receive 1000 reward points into a designated reward account if the customer purchases the product that was scanned. Another type of purchase incentive may be a cross-marketing inventive, wherein the purchase of product A will result in a purchase incentive for related product B. For example, a customer could scan the bar code on an IPOD device, and then receive from the inventive server computer a purchase incentive indicating that the customer will receive $5 off on the purchase of a set of headphones with the IPOD. Any type of purchase incentive may be used within the spirit and scope of this invention.

The purchase incentive database 28 may also have a product provider profile field 54. Stored in this field is a purchase incentive generation profile or algorithm that is associated with the product and determined by one or more of the product providers that may be giving the incentive to the customer. For example, the product provider may be the product manufacturer, in which case the product provider profile is controlled or requested by the manufacturer. Or, the product provider may be the merchant, in which case the product provider profile is controlled or requested by the merchant.

For example, a customer John Smith may scan the UPC of a 2-liter bottle of COCA-COLA soda at a supermarket. As explained previously, the UPC is decoded and the resulting product ID 4 (“65376-9899”) is sent along with the customer identification 16 (“7363562”) of John Smith via the network 10 to the incentive server computer 8. The processing circuitry 24 of the incentive server computer 8 will then use the product ID 4 to look up the associated purchase incentive data 52 from the purchase incentive database 28, which in this case provides an initial incentive 60 for 2-liter bottles of COCA-COLA soda in the amount of a fifty cent purchase discount. The processing circuitry 24 will also use the customer ID to look up the product preferences field 42 in the customer profile 32 for the customer associated with the customer ID (in this case John Smith). The product preferences field 42 in the customer profile 32 of John Smith indicates that he usually purchases PEPSI soda products. In this case, the product provider profile 54 for the 2 liter COCA COLA products is the “if use competitor then increase amount” algorithm. This algorithm causes the processing circuitry to increase the initial incentive from fifty cents to $1 since John Smith has been flagged usually purchasing PEPSI products as indicated in his product preferences 42, which would provide a greater incentive for John Smith to purchase the COCA-COLA product that he is considering. In an alternative example, if the customer profile of John Smith indicated that he usually purchased COCA-COLA products, he may be given less of an increase from the initial incentive (or that may be decreased if desired). Thus, he may in this case only be given a incentive purchase discount amount of 25 cents to purchase the COCA-COLA product since he needs less incentive to do so since he is already a habitual purchaser of those products. In sum, in this example, a customer that does not usually purchase the product he has scanned is given a larger incentive than a person who is already a customer of that brand. The variation of the initial incentive of a given product may be therefore controlled by one or more algorithms that are stored in or referenced by the product provider profile 54. If desired, the product provider profiles may be stored in a separate database that would be accessed by using the product ID 50 as described above. In one embodiment, only the manufacture ID portion of the UPC code is used to access a product provider profile 54 that is common across all products sold by that manufacturer. For example, if PEPSI desires to provide a purchase incentive of a 50% purchase discount for all of its products to any user who is flagged as being a COCA-COLA customer, then any product scanned that has a manufacture ID portion of 12345 will cause the desired algorithm to be used for effecting that incentive variation.

In an alternative embodiment, the product provider profile 54 of a first company may be accessed if the customer scans the UPC of a second company that sells a competing product. In this case, a purchase incentive may be given for the first company's product rather than the product that was scanned, thus providing an incentive for the customer to switch. For example, if customer John Smith scans a can of PEPSI soda, the manufacturer ID of the PEPSI company may retrieve a product provider profile from the COCA-COLA company from the database. This may provide an incentive for someone has scanned a PEPSI product. If for example, the initial incentive is for $1, this may be increased for customers who usually purchase PEPSI products to purchase a COCA-COLA product.

Other types of customer profile data may also be used within the spirit and scope of the invention, such as the customer's income range as shown in income field 38 of the customer profile database in FIG. 3. For example, if a customer scans a certain item, a greater incentive may be given to someone with a relatively smaller household income, and vice versa. This may be effected by the algorithm “if income <$150K then increase amount OR if income >$300K then decrease amount” as shown for the IPOD 20 GB in FIG. 4. Thus, if the customer John Smith scanned the UPC of an IPOD 20 GB, he would receive an increase in his $25 initial incentive since his income is less than $150K.

In many cases, the product provider is a single entity such as a manufacturer, merchant, or distributor. For example, the manufacturer APPLE may be the product provider that provides a dynamic purchase incentive for IPOD products. In this case, the incentive is funded by the manufacturer and may be accounted for any various ways as well known in the art. In another example, the merchant COSTCO may be the product provider that provides a dynamic purchase incentive for any desired product in its stores. This incentive may be cumulative to an incentive provided by the manufacturer. Thus, if COSTCO gives an additional $5 purchase incentive in addition to a $20 incentive provided by APPLE as the manufacturer, then COSTCO will fund that incentive as known in the art. There of course may be cases wherein the merchant may be the same entity as the manufacturer, such as the case wherein APPLE retail stores sell APPLE branded products. Thus, there may be multiple product providers that offer multiple purchase incentives for any given purchase scenario, if desired.

In another example, the region of the customer may affect the variation in the initial incentive. For example, if Mary Jones scans a 12 oz. bottle of PEPSI, then she will receive an increase of the initial incentive from 25 cents to 50 cents since that product has a product provider profile algorithm “if region=NE US then double amount” as shown in FIG. 4. Mary Jones lives in the northeast part of the United States (“NE US”) as indicated in her region field 40 as shown in FIG. 3. Therefore that algorithm would cause the incentive amount to double from 25 cents to 50 cents.

As described herein, the region field 40 sets forth the geographic region in which the customer lives. In addition, the current location of the customer may be used to provide a dynamic purchase incentive. The current location of the customer may be determined by using the location services of the purchasing device when that purchasing device is a portable device such as an IPHONE. Location services are well known in the art, and may provide the specific real-time location of the device by using methods such as cellphone tower triangulation or GPS techniques. For example, the device may determine its location at any given time by using an onboard GPS radio, and that GPS data may be included in the customer profile data in location field 41 that is sent to the incentive server computer. This will enable the incentive server computer to ascertain the near-exact location of the device at the time the customer is requesting a purchase incentive, and the incentive server computer may then use this information to adapt the incentive accordingly.

For example, assume the ACME store has registered with the incentive server as a product provider that would like to increase all incentive amounts provided by the manufacturer for any product scanned by a customer when that customer has scanned the product from within the ACME store. In this example, if the customer scans the code for a case of fruit drink, he may be given a $2.00 incentive by the manufacturer of the fruit drink as indicated in the incentive server. When that customer scans the fruit drink code within the ACME store, the GPS data in the data sent to the incentive server indicates his location at the ACME store and the algorithm used by the incentive server will then increase the incentive amount by $1 so the total incentive provided is $3. If the customer scans the same fruit drink at another store he would not receive the extra dollar discount since the GPS data indicates he was not inside the ACME store when the fruit drink product was scanned.

After the dynamic purchase incentive has been generated, a purchase incentive file representing the dynamic purchase incentive will be sent to the purchasing device via the network 10. The purchase incentive file will have incentive data required to provide the incentive, including a product identifier as well as the incentive amount and type (e.g. coupon, rebate, reward points etc.). There may also be an expiration date if so desired (obtained from expiration field 62), as well as customer identification information so the incentive is personal to the customer who scanned the product. A bar code with a unique purchase incentive identifier encoded in the bar code may also be included in the file. Other information, graphics etc. may also be in the purchase incentive file. The purchase incentive file may then be rendered at the purchasing device, for example by displaying it on the screen of the smartphone. In this embodiment, the customer may then present the incentive image to the cashier at the time of checkout. The bar code that identified the incentive may be scanned and the incentive amount may be applied to the purchase. This may be obtained from the bar code in the incentive image, or it may be retrieved from the incentive server computer via the network 10. In the alternative to displaying the incentive image when it is received at the smartphone, the incentive file may be simply stored in the smartphone and selected at a later time by the customer. In this case, a list of stored incentives may be available to enable the customer to retrieve the incentive from memory in an expedient fashion. In one embodiment, the incentive is deleted from the memory after it has expired as ascertained by the expiration date or time. For example, the incentive may be set to expire in 30 minutes, after which time it is no longer available for use by the customer. This provides an incentive for the customer to make the purchase in a quick manner.

In an alternative embodiment, the incentive amount may vary as a function of time after it has been stored at the purchasing device 6. There may be a countdown clock used and an algorithm that sets the incentive amount over time. For example, it may be established that the incentive amount will reduce by 10% every ten minutes after receipt at the purchasing device 6. There may be a graphic displayed that informs the customer of this decrease in value. In addition or in the alternative, an audible alarm may be generated to warn the customer of the decreasing value. In the case wherein the incentive image is displayed on the screen, the incentive amount that is displayed may flash every time it automatically decreases to warn the customer that he or she should use the incentive quickly.

After the incentive has been used at the point of sale, the purchasing device 6 (or the associated point of sale terminal) may transmit a notification message to the incentive server computer 8 indicating that the dynamic purchase incentive has been applied to the purchase of the product 2 by the customer, and the incentive server computer 8 then stores the notification in a product incentive redemption history file 26 in memory. The processing circuitry 24 of the incentive server computer 8 may be further programmed to analyze the product incentive redemption history file 26 in addition to the retrieved customer profile data and the purchase incentive data in order to generate a dynamic purchase incentive to be applied to the purchase of the product by the customer. For example, if the customer has downloaded many incentives for COCA-COLA but never redeemed them, the next time he scans a COCA-COLA product he may be given a greater incentive.

As described above, the input module of the purchasing device may include a bar code scanning module for scanning a bar code associated with the product (such as a UPC), the bar code being encoded with the product identification. In the alternative, the input module may include a radio frequency identification tag reading module for reading a radio frequency identification tag associated with the product, the radio frequency identification tag being encoded with the product identification. Or, the input module may include a near field communications module for reading an NFC encoded device. The input module may also be a keyboard for entering a text description of the product into the purchasing device.

The purchasing device is a point-of-sale terminal, or it may be a portable hand-held device with a memory for storing the dynamic purchase incentive to be applied to the purchase of the product at a subsequent time. Other embodiments of the purchasing device are described herein.

Other data in addition to the purchase incentive data and the customer profile data may be used in order to generate the purchase incentive. For example, in one embodiment, data indicative of weather conditions such as temperature in the geographic region of the customer may be used. In this embodiment, products that may be more desired on a hot day (such as outdoor water toys, beach clothing, etc.) may be given a different incentive than on cooler days. Similarly, cold weather items such as hot chocolate mix, pocket warmers, hats and gloves, etc. may be given different incentives on extremely cold days than on more temperate days. Weather predictions could also be used to modify the incentive, such as by providing greater incentives for snow shovels or snow blowers if a snowstorm is expected to arrive in the customer's geographic area.

In addition to using the weather to modify the value of a purchase incentive, the system may refer to calendar and/or time data for additional variations. The birthday of the customer may be stored in the customer profile, and that customer may be given additional incentives on or near his or her birthday. Similarly, certain holidays may cause variations in the incentive amounts given. For example, additional incentives may be provided by the system for picnic items and American flags on or near the July 4^{th} holiday, or football paraphernalia may have incentive variations on or near SuperBowl Sunday.

In a further embodiment, the amount of inventory for the product scanned by the consumer may also be relevant to the incentive amount provided by the system. That is, the product provider may indicate that the incentive amount should be lower if the inventory for a product falls below a certain floor, and conversely the incentive amount should be higher if the inventory for a product goes above a certain limit. For example, the product provider could require that a incentive amount of $1 off the purchase of a box of cereal be reduced to 50 cents when less than ten boxes of cereal remain in the store, and increased to $1.50 when ten or more boxes of cereal are in the store.

As set forth above, the term product when used in this invention includes physical goods as well as services that may be rendered, or a combination of both. The product description therefore also includes a services description. There may be a bar code printed on a document that may describe the services, such as an advertisement for the services. By scanning the code, the same purchase incentive generation occurs as with physical goods. For example, a spa may post a menu of services on a storefront window, and each service offered may have a bar code printed next to the associated description. The customer may use his device to scan the code of the desired service, and the incentive generation process occurs as described above.

The products provided may be in the form of a combination of goods and services, such as at a restaurant. For example, a menu may be provided outside the restaurant that lists all of the food items available in the restaurant. Also, a code may be printed that accesses a reservation schedule for that restaurant. By scanning the reservation schedule code, an algorithm is executed that provides the customer with the time that the next table is available for him. This may be based on a variety of factors such as current table availability, the frequency of previous visits by that customer, the amount of money previously spent by that customer, etc. In addition, the customer could scan the bar code of certain items on the menu, which will operate to generate purchase incentives as described above. The reservation time that is generated for that customer may also then be based on the food products he has scanned. For example, the algorithm may provide a table reservation sooner for a customer that has scanned expensive food items.

In one embodiment, the customer may generate a virtual incentive shopping cart that holds all of the purchase incentives received from the incentive server for a given time period or within a certain geographic region as determined by the GPS data. All of the purchase incentives may then be presented when the customer checks out such as by visiting a cashier at a physical store. The incentive server will track all of the incentives that have been sent to a given customer, and can also generate a cart bar code that references all of the incentives generated. This bar code may also be sent to the customer's device for subsequent presentation to the cashier. When the cashier scans the cart bar code, that cart bar code data is sent to the incentive server for retrieval of the associated incentives using the cart bar code as the reference point.

The embodiments described above utilize a pull methodology, wherein purchase incentives are generated and sent to the customer based on the customer trigger of scanning a bar code or entering a description of the desired product. In another aspect of the invention, push methodologies are implemented to provide the purchase incentives of this invention. In this aspect, the purchasing device sends GPS data (or other location services data) on a periodic basis to the incentive server computer. Once the purchasing device has entered a certain predefined location (such as a certain store), then purchase incentive server computer can generate incentives as described above, although the algorithms used will not take into account any product descriptions since the customer has not scanned any product codes in this embodiment. For example, a product provider may request that all customer who enter the ACME store be sent a purchase incentive for a certain product that ACME is trying to sell, which may vary based on all of the parameters described above such as income level, past purchase history, demographic profile, etc.

In another aspect of this invention, product providers may keep controls on the amount of incentives that they provide over a given time period. A running total may be kept for each product and/or product provider for incentives that are generated, and for those that are actually redeemed. A product provider may indicate a monthly limit on each value, after which no further incentives are generated, or reduced value incentives are generated. For example, the manufacturer PEPSI may have a redemption limit of $15,000 for each month, after which no further incentives are generated. The incentive server computer will track the incentives it serves and redeems in a month period, and will limit further redemption (or generation once that cap has been met). In the alternative, a sliding scale may be used so that incentive amounts will reduce as the cap is reached.

As described herein, the present invention enables product providers to control the generation of dynamic purchase incentives that are offered to customers based on many factors. This invention finds particular benefits when integrated with the online reward exchange inventions described in copending application Ser. Nos. 12/687,423; 12/703,265; 12/942,710; 13/040,971; and 13/076,216; which are assigned to the assignee of the present application and the specifications of which are incorporated herein. By integrating these inventions with each other, the functionality of the incentive server computer described herein may be undertaken by the online reward exchange computer of those applications. In this aspect, the merchants and manufacturers who are registered with the online reward exchange system described in those applications are able to easily control the parameters of the incentives generated with appropriate real-time or batch controls that enable variation of the product provider profiles used by the incentive server computer.

The present invention applies to physical shopping such as when a consumer scans a desired product at a brick and mortar store location in order to receive appropriate purchase incentives. As explained above, these purchase incentives are downloaded to the purchasing device, which may be a handheld portable device such as an IPHONE. In this case, the purchase incentive may be displayed to the cashier at the point of sale, and the purchase incentive is applied to the purchase. Also, the purchasing device may be a point of sale terminal, so that when a customer presents the product of interest to a cashier, he can easily scan the product bar code and receive the purchase incentives directly from the discount server computer without needing to interface with a handheld device of the customer. As explained above, the customer ID may be entered by the customer into the POS terminal as a separate step, or a credit card number may be used as the customer ID for the incentive server. This would have great applicability in an embodiment in which the credit card issuer operates the incentive server as part of or adjunct to the normal credit card operations. In this manner, a customer presents a desired product to a POS terminal, swipes his credit or debit card as part of the payment transaction, and the credit card issuer performs all of the functions of the incentive server computer as described herein. The purchase incentive is delivered to the POS terminal in the form of a discount for the current sale, a rebate that may be printed out or emailed to the customer, a batch of reward points added to a reward point account of the customer (such as one managed by the credit card issuer), etc.

In another variation, a kiosk is provided in the store as the purchasing device, at which the customer may scan the product bar code. The discount server computer can send the purchase incentives for that product directly to the POS terminal, or it could send them to an account of the customer for later use (such as by email), or it could send them to a printer connected to the kiosk to be printed for the customer for subsequent presentation to a POS cashier. In another embodiment, the customer may execute an online transaction with the purchasing device or a home PC. For example, the customer could simply pick up and scan a product of interest anywhere, and then receive a purchase incentive as described above, which is delivered directly to the purchasing device for use in an associated online purchase of the product.

In an alternative embodiment, the system will allow customers who have not yet registered to receive the benefits of the dynamic purchase incentive. In this embodiment, a cashier may scan a product presented by a non-registered customer, and an application running on the POS terminal may request a purchase incentive for the non-registered customer. Since non-registered customers will not have a customer profile in the customer profile database at the incentive server computer, the incentive server computer will generate purchase incentives using the purchase incentive data (i.e. the initial incentive) and those aspects of the product provider profile that do not require an analysis of any customer-specific data. For example, the product provider profile may indicate that an initial incentive of a $10 purchase discount may be increased for non-registered users to $12, or it may be decreased to $8 since the inventory is low on that product, etc. The purchase incentive sent to the POS device by the incentive server computer would then be displayed to the cashier and/or user, along with an optional message that may invite the customer to register with the incentive server computer for increased incentives at a later date. In the alternative, the purchase incentive may be offered to the customer on the condition that he or she register with the system at that time.

In a further embodiment, customers that are a member of a common group, such as a household, may be indicated in their customer profile 32 in the customer profile database 18. A field labeled “group ID” would exist in addition to those shown in FIG. 3. In the case where the group is a household, each member of that household would be assigned the same group ID number, which would be stored in each person's profile 32. The algorithms used to generate the dynamic purchase incentive could then look at customer profiles of other members in the same group (having the same group ID) when generating the purchase incentive. That is, when a certain customer scans a product and requests a purchase incentive, his group ID number is retrieved and then used to search the customer profile database for every other customer with the same group ID number. For example, if a customer scans a bottle of PEPSI, and all of the members of the household of that customer have a product preference of COCA-COLA, then the initial incentive amount may increase substantially more than if everyone else in the household has a product preference of PEPSI.

The present invention may also be used in a social networking environment. Purchase incentives received by customers may be traded amongst members of a social network to which that customer belongs. The system may require those other members to register in order to receive the benefit of the purchase incentive that has been traded.

As described above, the purchasing device may be a portable hand held device such as a smartphone that incorporates a display, input devices that may include a touchscreen and/or dedicated buttons, an imaging device (camera), a sound output such as a speaker or headset jack, computing circuitry including processing circuitry and memory, GPS radio, wireless communications devices for communicating with the network 10, and other circuits and interfaces as well known in the art. Also, as described above, the purchasing device may be a POS terminal or a kiosk located at a physical store, shopping mall or the like. The purchase incentive(s) delivered back to the purchasing device by the incentive server computer may be used immediately (electronically displayed or printed out), or they may be stored in memory for later use.

In an alternative embodiment, the present invention may be implemented with an interactive television purchasing system. In this embodiment, a typical system would have a set top box such as a cable box or satellite receiver, and a television monitor to which the set top box is connected. There is also usually a user remote control device which enables the user to make various selections from the display on the television monitor. For example, a shopping channel provided by a broadcaster such as CABLEVISION may be viewed by the user via the set top box, and the user may make certain selections on the remote control in order to obtain information about a product being displayed, or purchase a product being displayed. By applying the present invention to this system, the benefits of providing and obtaining a dynamic purchase incentive as described herein as attained.

In this embodiment, the set top box, display, and remote control device are considered in the aggregate to be the purchasing device. That is, the remote control provides the user input controls, the set top box provides the processing and communications functions, and the display monitor provides the display to the customer. So, for example, the customer may view an item of interest on the display, and then select a button on the remote control to indicate his interest in the product. This selection is received by the set top box and communicated to the broadcaster of the program. The broadcaster would operate the functionality of the incentive server computer as described above, and then return to the set top box the dynamic purchase incentive that it has generated. That may be a coupon or rebate as described above, which would be applied to the purchase of the item. The incentive may also be reward points, which would be added to a reward account of the customer, for example one managed by the broadcaster. The awarding of reward points could also be tied in with various programming rewards, such as those described in copending application Ser. No. 11/755,340, the specification of which is incorporated by reference herein. Or, the purchase incentive could be printed on a printer connected (such as by LAN) to the set top box for later use.

In the embodiments described above, the customer requests a purchase incentive from a product provider, who may be a merchant, a manufacturer, a distributor, etc. In an alternative embodiment, the customer may be a merchant who can obtain a purchase incentive from the product manufacturer based on the same or similar factors as previously discussed. In this embodiment, the merchant may be interested in purchasing a large quantity of products, which would be communicated to the incentive server computer (which may be operated by or on behalf of the manufacturer as the product provider). The customer profile would be correlated with the merchant as the customer for this transaction. This enables a manufacturer to dynamically generate incentives to its customers, who would be the merchants, in the same manner as described with respect to the primary embodiments. For example, a merchant BEST BUY may be interested in obtaining 1000 BluRay players from SONY as the product provider. BEST BUY may input into a purchasing device (e.g. a desktop computer, or a portable device such as an IPAD) an identification of the desired BluRay product by selecting it from a catalog description, or by scanning the UPC code as described above. The product ID for the desired BluRay player is sent to the SONY incentive server computer, which may be integrated into its purchasing system. Also, the customer ID for BEST BUY is sent to the SONY incentive server computer. The SONY incentive server computer then looks up the product incentive data from the product ID, as well as a BEST BUY profile from the customer profile database 18. The dynamic incentive generation proceeds as described above, and SONY can provide BEST BUY with incentives such as discounts as desired.

What is claimed is:

1. A computer-implemented method of providing a dynamic purchase incentive to a purchase of a product comprising the steps of:
a. inputting into a purchasing device a product identification that identifies a product desired to be purchased by a customer;
b. the purchasing device transmitting to an incentive server computer the product identification and customer identification data that identifies the customer;
c. the incentive server computer using the product identification to retrieve associated product incentive data from a purchase incentive database;
d. the incentive server computer using the customer identification data to retrieve associated customer profile data from a customer profile database;
e. the incentive server computer using the retrieved product incentive data and the retrieved customer profile data to generate a dynamic purchase incentive to be applied to the purchase of the product by the customer, the dynamic purchase incentive varying as a function of the retrieved product incentive data and the retrieved customer profile data; and
f. the incentive server computer transmitting the dynamic purchase incentive to the purchasing device.

2. The method of claim 1 further comprising the step of applying the dynamic purchase incentive to the purchase of the product by the customer.

3. The method of claim 1 wherein the step of inputting into a purchasing device a product identification that identifies a product desired to be purchased by a customer comprises scanning a bar code associated with the product, the bar code being encoded with the product identification.

4. The method of claim 3 wherein the bar code is a UPC bar code.

5. The method of claim 1 wherein the step of inputting into a purchasing device a product identification that identifies a product desired to be purchased by a customer comprises reading a radio frequency identification tag associated with the product, the radio frequency identification tag being encoded with the product identification.

6. The method of claim 1 wherein the step of inputting into a purchasing device a product identification that identifies a product desired to be purchased by a customer comprises entering a text description of the product into the purchasing device.

7. The method of claim 2 wherein the purchasing device is a point-of-sale terminal, and further wherein the dynamic purchase incentive is applied to the purchase of the product in real-time when the dynamic purchase incentive is received from the incentive server computer.

8. The method of claim 2 wherein the purchasing device is a portable hand-held device, and further wherein the dynamic purchase incentive is stored in a memory in the portable hand-held device to be applied to the purchase of the product at a subsequent time.

9. The method of claim 2 further comprising the steps of
transmitting a notification to the incentive server computer indicating that the dynamic purchase incentive has been applied to the purchase of the product by the customer; and
storing the notification in a product incentive redemption history file.

10. The method of claim 9 wherein the incentive server computer uses the product incentive redemption history file in addition to the retrieved product incentive data and the retrieved customer profile data in order to generate a dynamic purchase incentive to be applied to the purchase of the product by the customer.

11. The method of claim 1 wherein the incentive server computer uses a product provider profile file in addition to the retrieved product incentive data and the retrieved customer profile data in order to generate a dynamic purchase incentive to be applied to the purchase of the product by the customer.

12. The method of claim 11 wherein the product provider profile file is provided by a manufacturer of the product.

13. The method of claim 11 wherein the product provider profile file is provided by a merchant of the product.

14. The method of claim 11 wherein the product provider profile file is provided by a purchasing club.

15. The method of claim 1 wherein the customer profile data comprises prior purchase history data of the customer.

16. The method of claim 1 wherein the customer profile data comprises demographic data associated with the customer.

17. The method of claim 1 wherein the product incentive data comprises an initial incentive amount to be used in the dynamic purchase incentive.

18. The method of claim 17 wherein the incentive server computer uses the retrieved product incentive data and the retrieved customer profile data to generate a dynamic purchase incentive to be applied to the purchase of the product by the customer by varying the initial incentive amount as a function of the retrieved customer profile data.

19. The method of claim 1 wherein the dynamic purchase incentive comprises a discount coupon that gives the customer a discount on the purchase of the product.

20. The method of claim 1 wherein the dynamic purchase incentive comprises a discount coupon that gives the customer a discount on the purchase of a second product complementary to the product.

21. The method of claim 1 wherein the dynamic purchase incentive comprises reward points that are awarded to an account associated with the customer.

22. The method of claim 1 wherein the dynamic purchase incentive comprises a rebate.

23. The method of claim 1 wherein the incentive server computer uses current weather data in addition to the retrieved product incentive data and the retrieved customer profile data in order to generate a dynamic purchase incentive to be applied to the purchase of the product by the customer.

24. The method of claim 1 wherein the incentive server computer uses predictive weather data in addition to the retrieved product incentive data and the retrieved customer profile data in order to generate a dynamic purchase incentive to be applied to the purchase of the product by the customer.

25. The method of claim 1 wherein the incentive server computer uses calendar data in addition to the retrieved product incentive data and the retrieved customer profile data in order to generate a dynamic purchase incentive to be applied to the purchase of the product by the customer.

26. The method of claim 1 wherein the incentive server computer uses time data in addition to the retrieved product incentive data and the retrieved customer profile data in order to generate a dynamic purchase incentive to be applied to the purchase of the product by the customer.

27. The method of claim 1 wherein the incentive server computer uses product inventory data in addition to the retrieved product incentive data and the retrieved customer profile data in order to generate a dynamic purchase incentive to be applied to the purchase of the product by the customer.

28. The method of claim 1 wherein the purchasing device transmits to the incentive server computer location data that identifies the location of the purchasing device, and wherein the incentive server computer uses the location data in addition to the retrieved product incentive data and the retrieved customer profile data in order to generate a dynamic purchase incentive to be applied to the purchase of the product by the customer.

29. The method of claim 28 wherein the location data comprises GPS data.

30. The method of claim 1 wherein the product is a good.

31. The method of claim 1 wherein the product is a service.

32. The method of claim 1 further comprising the step of logging the transmitted purchase incentive in a distributed purchase incentives file at the incentive server computer.

33. The method of claim 32 further comprising the step of limiting subsequent purchase incentives based on the transmitted purchase incentives logged in the distributed purchase incentives file.

34. The method of claim 1 wherein a plurality of purchase incentives are generated by the incentive server computer and transmitted to the purchasing device, each of the purchase incentives being associated with a product to be purchased by the customer, and further wherein the plurality of purchase incentives are stored at the purchasing device for subsequent use by the customer in purchasing the associated products.

35. The method of claim 1 wherein the customer is a member of a group of related customers, and wherein each related customer has an associated customer profile stored in the customer profile database, and wherein the customer profiles associated with each of the related customers in the group are retrieved from the customer profile database and used in order to generate a dynamic purchase incentive to be applied to the purchase of the product by the customer.

36. The method of claim 35 wherein the customer profile of each of the group of related customers additionally comprises a group identification number that is the same for each of the related customers, and wherein the customer profiles associated with each of the related customers in the group are retrieved from the customer profile database by referencing the group identification number.

37. A computer-implemented method by an incentive server computer for providing a dynamic purchase incentive to a purchase of a product by a customer comprising the steps of:
a. the incentive server computer receiving from a purchasing device a product identification that identifies a product desired to be purchased by a customer and customer identification data that identifies the customer;
b. the incentive server computer using the product identification to retrieve associated product incentive data from a purchase incentive database;
c. the incentive server computer using the customer identification data to retrieve associated customer profile data from a customer profile database;
d. the incentive server computer using the retrieved product incentive data and the retrieved customer profile data to generate a dynamic purchase incentive to be applied to the purchase of the product by the customer, the dynamic purchase incentive varying as a function of the retrieved product incentive data and the retrieved customer profile data; and
e. the incentive server computer transmitting the dynamic purchase incentive to the purchasing device for application to the purchase of the product by the customer.

38. The method of claim 37 further comprising the steps of
receiving from the purchasing device a notification indicating that the dynamic purchase incentive has been applied to the purchase of the product by the customer; and
storing the notification in a product incentive redemption history file.

39. The method of claim 38 wherein the incentive server computer uses the product redemption history file in addition to the retrieved product incentive data and the retrieved customer profile data in order to generate a dynamic purchase incentive to be applied to the purchase of the product by the customer.

40. The method of claim 37 wherein the incentive server computer uses a product provider profile file in addition to the retrieved product incentive data and the retrieved customer profile data in order to generate a dynamic purchase incentive to be applied to the purchase of the product by the customer.

41. The method of claim 37 wherein the customer profile data comprises prior purchase history data of the customer.

42. The method of claim 37 wherein the customer profile data comprises demographic data associated with the customer.

43. The method of claim 37 wherein the product incentive data comprises an initial incentive amount to be used in the dynamic purchase incentive.

44. The method of claim 43 wherein the incentive server computer uses the retrieved product incentive data and the retrieved customer profile data to generate a dynamic purchase incentive to be applied to the purchase of the product by the customer by varying the initial incentive amount as a function of the retrieved customer profile data.

45. The method of claim 37 wherein the dynamic purchase incentive comprises a discount coupon that gives the customer a discount on the purchase of the product.

46. The method of claim 37 wherein the dynamic purchase incentive comprises a discount coupon that gives the customer a discount on the purchase of a second product complementary to the product.

47. The method of claim 37 wherein the dynamic purchase incentive comprises reward points that are awarded to an account associated with the customer.

48. The method of claim 37 wherein the dynamic purchase incentive comprises a rebate.

49. The method of claim 37 wherein the incentive server computer uses current weather data in addition to the retrieved product incentive data and the retrieved customer profile data in order to generate a dynamic purchase incentive to be applied to the purchase of the product by the customer.

50. The method of claim 37 wherein the incentive server computer uses predictive weather data in addition to the retrieved product incentive data and the retrieved customer profile data in order to generate a dynamic purchase incentive to be applied to the purchase of the product by the customer.

51. The method of claim 37 wherein the incentive server computer uses calendar data in addition to the retrieved product incentive data and the retrieved customer profile data in order to generate a dynamic purchase incentive to be applied to the purchase of the product by the customer.

52. The method of claim 37 wherein the incentive server computer uses time data in addition to the retrieved product incentive data and the retrieved customer profile data in order to generate a dynamic purchase incentive to be applied to the purchase of the product by the customer.

53. The method of claim 37 wherein the incentive server computer uses product inventory data in addition to the retrieved product incentive data and the retrieved customer profile data in order to generate a dynamic purchase incentive to be applied to the purchase of the product by the customer.

54. The method of claim 37 wherein the product is a good.

55. The method of claim 37 wherein the product is a service.

56. The method of claim 37 wherein the product is a combination of a good and a service.

57. The method of claim 37 further comprising the step of logging the transmitted purchase incentive in a distributed purchase incentives file at the incentive server computer.

58. The method of claim 57 further comprising the step of limiting subsequent purchase incentives based on the transmitted purchase incentives logged in the distributed purchase incentives file.

59. A computer-implemented method of a purchasing device obtaining a dynamic purchase incentive to a purchase of a product comprising the steps of:
a. inputting into a purchasing device a product identification that identifies a product desired to be purchased by a customer;
b. the purchasing device transmitting to an incentive server computer the product identification and customer identification data that identifies the customer; and
c. the purchasing device receiving from the incentive server computer a dynamic purchase incentive to be applied to the purchase of the product by the customer, the dynamic purchase incentive being generated by the incentive server computer using the product identification to retrieve associated product incentive data from a purchase incentive database and using the customer identification data to retrieve associated customer profile data from a customer profile database and using the retrieved product incentive data and the retrieved customer profile data to generate the dynamic purchase incentive to be applied to the purchase of the product by the customer, the dynamic purchase incentive varying as a function of the retrieved product incentive data and the retrieved customer profile data.

60. The method of claim 59 wherein the step of inputting into a purchasing device a product identification that identifies a product desired to be purchased by a customer comprises scanning a bar code associated with the product, the bar code being encoded with the product identification.

61. The method of claim 60 wherein the bar code is a UPC bar code.

62. The method of claim 59 wherein the step of inputting into a purchasing device a product identification that identifies a product desired to be purchased by a customer comprises reading a radio frequency identification tag associated with the product, the radio frequency identification tag being encoded with the product identification.

63. The method of claim 59 wherein the step of inputting into a purchasing device a product identification that identifies a product desired to be purchased by a customer comprises entering a text description of the product into the purchasing device.

64. The method of claim 59 further comprising the step of applying the dynamic purchase incentive to the purchase of the product by the customer.

65. The method of claim 64 wherein the purchasing device is a point-of-sale terminal, and further wherein the dynamic purchase incentive is applied to the purchase of the product in real-time when the dynamic purchase incentive is received from the incentive server computer.

66. The method of claim 64 wherein the purchasing device is a portable hand-held device, and further wherein the dynamic purchase incentive is stored in a memory in the portable hand-held device to be applied to the purchase of the product at a subsequent time.

67. The method of claim 64 further comprising the step of transmitting a notification to the incentive server computer indicating that the dynamic purchase incentive has been applied to the purchase of the product by the customer.

68. The method of claim 59 wherein the purchasing device transmits to the incentive server computer location data that identifies the location of the purchasing device to be used by the incentive server computer in addition to the retrieved product incentive data and the retrieved customer profile data in order to generate a dynamic purchase incentive to be applied to the purchase of the product by the customer.

69. The method of claim 68 wherein the location data comprises GPS data.

70. The method of claim 59 wherein a plurality of purchase incentives generated by the incentive server computer are received by the purchasing device, each of the purchase incentives being associated with a product to be purchased by the customer, and further wherein the plurality of purchase incentives are stored at the purchasing device for subsequent use by the customer in purchasing the associated products.

71. A computer-implemented method of providing a dynamic purchase incentive to a purchase of a product comprising the steps of:
a. a purchasing device transmitting to an incentive server computer location data that identifies the location of the purchasing device and customer identification data that identifies a customer associated with the purchasing device;
b. the incentive server computer retrieving product incentive data from a purchase incentive database;
c. the incentive server computer using the customer identification data to retrieve associated customer profile data from a customer profile database;
d. the incentive server computer using the retrieved product incentive data and the retrieved customer profile data to generate a dynamic purchase incentive to be applied to the purchase of the product by the customer, the dynamic purchase incentive varying as a function of the retrieved product incentive data and the retrieved customer profile data; and
e. the incentive server computer transmitting the dynamic purchase incentive to the purchasing device.

72. The method of claim 71 further comprising the set of applying the dynamic purchase incentive to the purchase of the product by the customer.

73. The method of claim 71 wherein the location data comprises GPS data.

74. The method of claim 71 wherein the incentive server computer compares the location data received from the purchasing device with a predefined location perimeter stored at the incentive server computer, and wherein the incentive server computer generates the dynamic purchase incentive only when the incentive server computer determines that the purchasing device is near the predefined location perimeter based on the location data comparison.

75. The method of claim 74 wherein the product incentive data retrieved from the purchase incentive database at the incentive server computer is associated with the predefined location perimeter.

76. The method of claim 71 wherein the customer profile data comprises prior purchase history data of the customer.

77. The method of claim 71 wherein the customer profile data comprises demographic data associated with the customer.

78. The method of claim 71 wherein the product incentive data comprises an initial incentive amount to be used in the dynamic purchase incentive.

79. The method of claim 78 wherein the incentive server computer uses the retrieved product incentive data and the retrieved customer profile data to generate a dynamic purchase incentive to be applied to the purchase of the product by the customer by varying the initial incentive amount as a function of the retrieved customer profile data.

80. The method of claim 72 further comprising the steps of
transmitting a notification to the incentive server computer indicating that the dynamic purchase incentive has been applied to the purchase of the product by the customer; and
storing the notification in a product incentive redemption history file.

81. The method of claim 80 wherein the incentive server computer uses the product incentive redemption history file in addition to the retrieved product incentive data and the retrieved customer profile data in order to generate a dynamic purchase incentive to be applied to the purchase of the product by the customer.

82. A computer-implemented method of providing a dynamic purchase incentive to a purchase of a product comprising the steps of:
a. inputting into a purchasing device a product identification that identifies a product desired to be purchased by a customer;
b. the purchasing device transmitting to an incentive server computer the product identification;
c. the incentive server computer using the product identification to retrieve associated product incentive data from a purchase incentive database;
d. the incentive server computer using the retrieved product incentive data to generate a dynamic purchase incentive to be applied to the purchase of the product by the customer, the dynamic purchase incentive varying as a function of the retrieved product incentive data; and
e. the incentive server computer transmitting the dynamic purchase incentive to the purchasing device.

83. The method of claim 82 wherein the step of inputting into a purchasing device a product identification that identifies a product desired to be purchased by a customer comprises scanning a bar code associated with the product, the bar code being encoded with the product identification.

84. The method of claim 83 wherein the bar code is a UPC bar code.

85. The method of claim 82 wherein the step of inputting into a purchasing device a product identification that identifies a product desired to be purchased by a customer comprises reading a radio frequency identification tag associated with the product, the radio frequency identification tag being encoded with the product identification.

86. The method of claim 82 wherein the step of inputting into a purchasing device a product identification that identifies a product desired to be purchased by a customer comprises entering a text description of the product into the purchasing device.

87. The method of claim 82 further comprising the set of applying the dynamic purchase incentive to the purchase of the product by the customer.

88. The method of claim 87 wherein the purchasing device is a point-of-sale terminal, and further wherein the dynamic purchase incentive is applied to the purchase of the product in real-time when the dynamic purchase incentive is received from the incentive server computer.

89. The method of claim 87 further comprising the steps of
transmitting a notification to the incentive server computer indicating that the dynamic purchase incentive has been applied to the purchase of the product by the customer; and
storing the notification in a product incentive redemption history file.

90. The method of claim 82 wherein the incentive server computer uses a product provider profile file in addition to the retrieved product incentive data and the retrieved customer profile data in order to generate a dynamic purchase incentive to be applied to the purchase of the product by the customer.

91. The method of claim 82 wherein the product incentive data comprises an initial incentive amount to be used in the dynamic purchase incentive.

92. The method of claim 91 wherein the incentive server computer uses the retrieved product incentive data and the retrieved customer profile data to generate a dynamic purchase incentive to be applied to the purchase of the product by the customer by varying the initial incentive amount as a function of the retrieved customer profile data.

93. A dynamic incentive purchasing system comprising:
A) a purchasing device comprising:
an input module for inputting a product identification that identifies a product desired to be purchased by a customer;
a first data transmission communications module for transmitting over a network to an incentive server computer the product identification and customer identification data that identifies the customer, and for receiving from the incentive server computer a dynamic purchase incentive to be applied to the purchase of the product by the customer; and
B) an incentive server computer selectively interconnected with the purchasing device over a network, the incentive server computer comprising:
a second data transmission communications module for receiving from the purchasing device the product identification and customer identification data that identifies the customer, and for transmitting to the purchasing device the dynamic purchase incentive to be applied to the purchase of the product by the customer;
a purchase incentive database that stores product incentive data associated with product identification data;
a customer profile database that stores customer profile data associated with customer identification data; and
processing circuitry programmed to use the product identification data to retrieve associated product incentive data from the purchase incentive database, use the customer identification data to retrieve associated customer profile data from the customer profile database, and analyze the retrieved product incentive data and the retrieved customer profile data to generate the dynamic purchase incentive to be applied to the purchase of the product by the customer, the dynamic purchase incentive varying as a function of the retrieved product incentive data and the retrieved customer profile data.

94. The system of claim 93 wherein the input module comprises a bar code scanning module for scanning a bar code associated with the product, the bar code being encoded with the product identification.

95. The system of claim 94 wherein the bar code scanning module comprises an image capture device for capturing an image of the bar code from the product.

96. The system of claim 93 wherein the input module comprises a radio frequency identification tag reading module for reading a radio frequency identification tag associated with the product, the radio frequency identification tag being encoded with the product identification.

97. The system of claim 93 wherein the input module comprises a keyboard for entering a text description of the product into the purchasing device.

98. The system of claim 93 wherein the purchasing device is a point-of-sale terminal.

99. The system of claim 93 wherein the purchasing device is a portable hand-held device comprising a memory for storing the dynamic purchase incentive to be applied to the purchase of the product at a subsequent time.

100. The system of claim 93 wherein the purchasing device transmits a notification to the incentive server computer indicating that the dynamic purchase incentive has been applied to the purchase of the product by the customer; and wherein the incentive server computer stores the notification in a product incentive redemption history file in memory.

101. The system of claim 100 wherein the processing circuitry of the incentive server computer is further programmed to analyze the product incentive redemption history file in addition to the retrieved product incentive data and the retrieved customer profile data in order to generate a dynamic purchase incentive to be applied to the purchase of the product by the customer.

102. The system of claim 93 wherein the processing circuitry of the incentive server computer is further programmed to analyze a product provider profile file in addition to the retrieved product incentive data and the retrieved customer profile data in order to generate a dynamic purchase incentive to be applied to the purchase of the product by the customer.

103. The system of claim 102 wherein the product provider profile file is provided by a manufacturer of the product.

104. The system of claim 102 wherein the product provider profile file is provided by a merchant of the product.

105. The system of claim 102 wherein the product provider profile file is provided by a purchasing club.

106. The system of claim 93 wherein the customer profile data comprises prior purchase history data of the customer.

107. The system of claim 93 wherein the customer profile data comprises demographic data associated with the customer.

108. The system of claim 93 wherein the product incentive data comprises an initial incentive amount to be used in the dynamic purchase incentive.

109. The system of claim 108 wherein the incentive server computer is programmed to analyze the retrieved product incentive data and the retrieved customer profile data to generate a dynamic purchase incentive to be applied to the purchase of the product by the customer by varying the initial incentive amount as a function of the retrieved customer profile data.

110. The system of claim 93 wherein the dynamic purchase incentive comprises a discount coupon that gives the customer a discount on the purchase of the product.

111. The system of claim 93 wherein the dynamic purchase incentive comprises a discount coupon that gives the customer a discount on the purchase of a second product complementary to the product.

112. The system of claim 93 wherein the dynamic purchase incentive comprises reward points that are awarded to an account associated with the customer.

113. The system of claim 93 wherein the dynamic purchase incentive comprises a rebate.

114. The system of claim 93 wherein the incentive server computer is programmed to use current weather data in addition to the retrieved product incentive data and the retrieved customer profile data in order to generate a dynamic purchase incentive to be applied to the purchase of the product by the customer.

115. The system of claim 93 wherein the incentive server computer is programmed to use predictive weather data in addition to the retrieved product incentive data and the retrieved customer profile data in order to generate a dynamic purchase incentive to be applied to the purchase of the product by the customer.

116. The system of claim 93 wherein the incentive server computer is programmed to use calendar data in addition to the retrieved product incentive data and the retrieved customer profile data in order to generate a dynamic purchase incentive to be applied to the purchase of the product by the customer.

117. The system of claim 93 wherein the incentive server computer is programmed to use time data in addition to the retrieved product incentive data and the retrieved customer profile data in order to generate a dynamic purchase incentive to be applied to the purchase of the product by the customer.

118. The system of claim 93 wherein the incentive server computer is programmed to use product inventory data in addition to the retrieved product incentive data and the retrieved customer profile data in order to generate a dynamic purchase incentive to be applied to the purchase of the product by the customer.

119. The system of claim 93 wherein the purchasing device transmits to the incentive server computer location data that identifies the location of the purchasing device, and wherein the incentive server computer is programmed to use the location data in addition to the retrieved product incentive data and the retrieved customer profile data in order to generate a dynamic purchase incentive to be applied to the purchase of the product by the customer.

120. The system of claim 119 wherein the location data comprises GPS data.

121. The system of claim 93 wherein the incentive server computer is programmed to log the transmitted purchase incentive in a distributed purchase incentives file.

122. The system of claim 121 wherein the incentive server computer is programmed to limit subsequent purchase incentives based on the transmitted purchase incentives logged in the distributed purchase incentives file.

123. The system of claim 93 wherein a plurality of purchase incentives are generated by the incentive server computer and transmitted to the purchasing device, each of the purchase incentives being associated with a product to be purchased by the customer, and further wherein the plurality of purchase incentives are stored at the purchasing device for subsequent use by the customer in purchasing the associated products.

124. The system of claim 93 wherein the customer is a member of a group of related customers, and wherein each related customer has an associated customer profile stored in the customer profile database, and wherein the customer profiles associated with each of the related customers in the group are retrieved from the customer profile database and used in order to generate a dynamic purchase incentive to be applied to the purchase of the product by the customer.

125. The system of claim 124 wherein the customer profile of each of the group of related customers additionally comprises a group identification number that is the same for each of the related customers, and wherein the customer profiles associated with each of the related customers in the group are retrieved from the customer profile database by referencing the group identification number.

126. An incentive server computer for providing a dynamic purchase incentive to a purchase of a product by a customer comprising:
a data transmission communications module for receiving from a purchasing device product identification that identifies a product desired to be purchased by a customer and customer identification data that identifies the customer, and for transmitting to the purchasing device a dynamic purchase incentive to be applied to the purchase of the product by the customer;
a purchase incentive database that stores product incentive data associated with product identification data;
a customer profile database that stores customer profile data associated with customer identification data; and
processing circuitry programmed to use the product identification data to retrieve associated product incentive data from the purchase incentive database, use the customer identification data to retrieve associated customer profile data from the customer profile database, and analyze the retrieved product incentive data and the retrieved customer profile data to generate the dynamic purchase incentive to be applied to the purchase of the product by the customer, the dynamic purchase incentive varying as a function of the retrieved product incentive data and the retrieved customer profile data.

127. The incentive server computer of claim 126 further comprising memory for storing a notification in a product incentive redemption history file, the notification received from the purchasing device indicating that the dynamic purchase incentive has been applied to the purchase of the product by the customer.

128. The incentive server computer of claim 127 wherein the processing circuitry is further programmed to analyze the product incentive redemption history file in addition to the retrieved product incentive data and the retrieved customer profile data in order to generate a dynamic purchase incentive to be applied to the purchase of the product by the customer.

129. The incentive server computer of claim 126 wherein the processing circuitry is further programmed to analyze a product provider profile file in addition to the retrieved product incentive data and the retrieved customer profile data in order to generate a dynamic purchase incentive to be applied to the purchase of the product by the customer.

130. The incentive server computer of claim 126 wherein the customer profile data comprises prior purchase history data of the customer.

131. The incentive server computer of claim 126 wherein the customer profile data comprises demographic data associated with the customer.

132. The incentive server computer of claim 126 wherein the product incentive data comprises an initial incentive amount to be used in the dynamic purchase incentive.

133. The incentive server computer of claim 132 wherein the incentive server computer is programmed to analyze the retrieved product incentive data and the retrieved customer profile data to generate a dynamic purchase incentive to be applied to the purchase of the product by the customer by varying the initial incentive amount as a function of the retrieved customer profile data.

134. The incentive server computer of claim 126 wherein the dynamic purchase incentive comprises a discount coupon that gives the customer a discount on the purchase of the product.

135. The incentive server computer of claim 126 wherein the dynamic purchase incentive comprises a discount coupon that gives the customer a discount on the purchase of a second product complementary to the product.

136. The incentive server computer of claim 126 wherein the dynamic purchase incentive comprises reward points that are awarded to an account associated with the customer.

137. The incentive server computer of claim 126 wherein the dynamic purchase incentive comprises a rebate.

138. The incentive server computer of claim 126 further programmed to use current weather data in addition to the retrieved product incentive data and the retrieved customer profile data in order to generate a dynamic purchase incentive to be applied to the purchase of the product by the customer.

139. The incentive server computer of claim 126 further programmed to use predictive weather data in addition to the retrieved product incentive data and the retrieved customer profile data in order to generate a dynamic purchase incentive to be applied to the purchase of the product by the customer.

140. The incentive server computer of claim 126 further programmed to use calendar data in addition to the retrieved product incentive data and the retrieved customer profile data in order to generate a dynamic purchase incentive to be applied to the purchase of the product by the customer.

141. The incentive server computer of claim 126 further programmed to use time data in addition to the retrieved product incentive data and the retrieved customer profile data in order to generate a dynamic purchase incentive to be applied to the purchase of the product by the customer.

142. The incentive server computer of claim 126 further programmed to use product inventory data in addition to the retrieved product incentive data and the retrieved customer profile data in order to generate a dynamic purchase incentive to be applied to the purchase of the product by the customer.

143. The incentive server computer of claim 126 further programmed to receive location data that identifies the location of the purchasing device, and further programmed to use the location data in addition to the retrieved product incentive data and the retrieved customer profile data in order to generate a dynamic purchase incentive to be applied to the purchase of the product by the customer.

144. The incentive server computer of claim 143 wherein the location data comprises GPS data.

145. The incentive server computer of claim 126 further programmed to log the transmitted purchase incentive in a distributed purchase incentives file.

146. The incentive server computer of claim 145 further programmed to limit subsequent purchase incentives based on the transmitted purchase incentives logged in the distributed purchase incentives file.

147. The incentive server computer of claim 126 wherein the customer is a member of a group of related customers, and wherein each related customer has an associated customer profile stored in the customer profile database, and wherein the customer profiles associated with each of the related customers in the group are retrieved from the customer profile database and used in order to generate a dynamic purchase incentive to be applied to the purchase of the product by the customer.

148. The incentive server computer of claim 147 wherein the customer profile of each of the group of related customers additionally comprises a group identification number that is the same for each of the related customers, and wherein the customer profiles associated with each of the related customers in the group are retrieved from the customer profile database by referencing the group identification number.

149. A purchasing device comprising:
an input module for inputting a product identification that identifies a product desired to be purchased by a customer; and
a data transmission communications module for transmitting over a network to an incentive server computer the product identification and customer identification data that identifies the customer, and for receiving from the incentive server computer a dynamic purchase incentive to be applied to the purchase of the product by the customer, the dynamic purchase incentive being generated by the incentive server computer using the customer identification data to retrieve associated customer profile data from a customer profile database and using the retrieved customer profile data and the product identification to generate the dynamic purchase incentive to be applied to the purchase of the product by the customer, the dynamic purchase incentive varying as a function of the retrieved customer profile data and the product identification.

150. The purchasing device of claim 149 wherein the input module comprises a bar code scanning module for scanning a bar code associated with the product, the bar code being encoded with the product identification.

151. The purchasing device of claim 150 wherein the bar code scanning module comprises an image capture device for capturing an image of the bar code from the product.

152. The purchasing device of claim 149 wherein the input module comprises a radio frequency identification tag reading module for reading a radio frequency identification tag associated with the product, the radio frequency identification tag being encoded with the product identification.

153. The purchasing device of claim 149 wherein the input module comprises a keyboard for entering a text description of the product into the purchasing device.

154. The purchasing device of claim 149 wherein the purchasing device is a point-of-sale terminal.

155. The purchasing device of claim 149 wherein the purchasing device is a portable hand-held device comprising a memory for storing the dynamic purchase incentive to be applied to the purchase of the product at a subsequent time.

156. The purchasing device of claim 149 wherein the purchasing device transmits a notification to the incentive server computer indicating that the dynamic purchase incentive has been applied to the purchase of the product by the customer.
